(19) United States
(12) Patent Application Publication
(10) Pub. No.: US 2013/0215639 A1
(43) Pub. Date: Aug. 22, 2013

(54) Light Guide Device, Front-Light Module And Reflective Display Apparatus

(71) Applicant: Entire Technology Co., Ltd., (US)

(72) Inventors: Hao-Xiang Lin, Ping-Zhen City (TW); Yan-Zuo Chen, Ping-Zhen City (TW); Wen-Feng Cheng, Ping-Zhen City (TW); Li-Ping Cho, Ping-Zhen City (TW)

(73) Assignee: ENTIRE TECHNOLOGY CO., LTD., Ping-Zhen City (TW)

(21) Appl. No.: 13/760,289

(22) Filed: Feb. 6, 2013

(30) Foreign Application Priority Data
Feb. 18, 2012 (TW) 101103977

(51) Int. Cl. F21V 8/00

(52) U.S. Cl. CPC G02B 6/0011
USPC 362/603; 385/146

(57) ABSTRACT

A light guide device includes a main body, a first surface, and a plurality of cloud form microstructures. The plurality of cloud form microstructures is disposed on the first surface. Each of the cloud form microstructures has an outer contour which is consisted of at least three connecting points and a plurality of curved lines formed by connecting adjacent connecting points. Each the cloud form microstructure is defined with a maximum length (L), a maximum width (W) perpendicular to the maximum length, and a maximum height (H) perpendicular to both the maximum length and the maximum width; wherein, the ratio of L to W is between 1:1 and 5:1, and the ratio of L to H is between 2.5:1 and 36:1.

This application claims the benefit of Taiwan Patent Application Serial No. 101103977, filed Feb. 8, 2012, the subject matter of which is incorporated herein by reference.

### BACKGROUND OF INVENTION

1. Field of the Invention

The invention relates to light guide device and a reflective display apparatus, and more particularly to the light guide device that is mounted in front of a reflective display so as to enhance the resolution of reflective display.

2. Description of the Prior Art

Currently, in the art of the LCD device, transmissive LCDs and reflective LCDs are two major types of the LCD screens.

The transmissive LCD is structured to have a backlight module behind the back (i.e. the incident plane) of the transmissive LCD panel. The backlight module generally includes a light guide plate, a light source and so on. A top broad surface and an opposing bottom surface of the light guide plate are defined as an emitting surface and a reflective surface, respectively; in which the emitting surface of the light guide plate is adhered tightly to the back (the incident plane) of the transmissive LCD and the light source is mounted outside to a narrow incident surface at a lateral side of the light guide plate. Lights emitted by the light source enter the light guide plate by penetrating the lateral narrow incident surface thereof, then are reflected inside the light guide plate by the bottom reflective surface, and finally leave the light guide plate from the upper emitting surface. The lights leaving the light guide plate then penetrate through the transmissive LCD on top of the light guide plate. Upon such an arrangement, images on the transmissive LCD can be displayed.

On the other hand, the reflective LCD is structured to have a front-light module on an upper surface (i.e. a display surface) of the reflective LCD. The front-light module can introduce lights from a foreign illumination source or a built-in light source to project on the upper surface of the reflective LCD. The lights are then reflected by upper surface of the reflective LCD and emitted from an emitting surface of the front-light module. Thereby, the images on the reflective LCD can be displayed.

Nevertheless, no matter what type of the light module, front or back, is used. The topics in evaluating the LCD devices are still embedded in the illumination homogeneity, effects of reduced illumination from a distant light source, display resolution of the e-books or display apparatuses. Due to the instinctive position differences between the backlight module and the front-light module in the LCD apparatus, the optical path, optical performance and structural requirements of the light guide plate for the front-light module are totally different to those of the light guide for the backlight module. Hence, optical design and device structuring in constructing a particular LCD device shall be more attentive.

### SUMMARY OF THE INVENTION

Accordingly, it is the primary object of the present invention to provide a light guide plate and a front-light module having the same light guide plate, in which the light guide plate is mounted in front of a display surface of an LCD for providing a planar light source to illuminate a reflective display panel so as to demonstrate a clear image on the reflective display apparatus.

It is another object of the present invention to provide a reflective display apparatus, which has the aforesaid front-light module to present a clear image.

In the present invention, a light guide device to be located laterally to a display surface of the reflective display panel includes a main body, a first surface and a plurality of cloud form microstructures. The first surface is located at a side of the main body distant from the display surface. The plurality of cloud form microstructures are disposed on the first surface for allowing lights inside the light guide plate to leave the displace surface. Each cloud form microstructure has an outer contour consisted of at least three connecting points and a plurality of curved lines formed by connecting adjacent connecting points. Homogeneity in the light guide device can be achieved by adjusting the distribution density of the microstructures according to the respective distances to the light source.

In one embodiment of the present invention, a ratio of the maximum length (L) of the cloud form microstructure to the maximum width (W) thereof perpendicular to the maximum length is preferred to be ranged between 1:1 and 5:1, while a ratio of the maximum length (L) to the maximum height (H) thereof is preferred to be ranged between 2.5:1 and 36:1.

In one embodiment of the present invention, the surface scratch-resisting parameter under steel wire abrasion for the light guide device is up to 100 cycles/150 g, the anti-fouling parameter is ranged between 90° and 150° in the water contact angle, the hardness parameter is ranged between HB and 6H, and the anti-finger print property is fallen between class “invisible” and class “visible but easy-to-be-brushed off”.

In one embodiment of the present invention, the material for the main body can be a single optical material or a composite optical material.

In one embodiment of the present invention, each of the curved lines for the cloud form microstructure can be a portion of a circle, which is defined by a diameter (GS), a center, a curvature radius (GS/2), and an angle θᵢ formed by the two connecting points (the two ends of the curved line) and the center, in which the L is no less than the W and the W is larger than three times of the GS.

In one embodiment of the present invention, the GS is ranged between 40 μm and 200 μm, and the θᵢ is ranged between 45° and 180°.

In one embodiment of the present invention, the cloud form microstructure further includes at least one micro area equal-height with the first surface. The area percentage of said at least one micro area to the cloud form microstructure is less than 10%, and the coverage percentage of the cloud form microstructures on a unit area is ranged between 65% and 95%.

In the present invention, a reflective display apparatus can include a light source and the aforesaid light guide device mounted laterally to the display surface of the reflective display panel.

All these objects are achieved by the light guide device, front-light module and reflective display apparatus described below.

### BRIEF DESCRIPTION OF THE DRAWINGS

The present invention will now be specified with reference to its preferred embodiment illustrated in the drawings, in which:

FIG. 1 is a schematic cross-sectional view of a first embodiment of the reflective display apparatus in accordance with the present invention;

FIG. 2 is a schematic enlarged top view of an embodiment of the cloud form microstructure in accordance with the present invention;

FIG. 3A is a schematic view of a concave surface of the tooling for producing the cloud form microstructures of the present invention;

FIG. 3B schematically shows one embodiment of the cloud form microstructure in accordance with the present invention, produced from a tooling like the one shown in FIG. 3A;

FIG. 3C schematically shows another embodiment of the cloud form microstructure in accordance with the present invention, produced from a tooling like the one shown in FIG. 3A;

FIG. 3D schematically shows a further embodiment of the cloud form microstructure in accordance with the present invention, produced from a tooling like the one shown in FIG. 3A;

FIG. 4 is a perspective view of FIG. 1;

FIG. 5A shows typically a first optical path on the first surface of the light guide device having the cloud form microstructures thereon in accordance with the present invention;

FIG. 5B shows measurements from FIG. 5A,

FIG. 6A shows typically a second optical path on the first surface of the light guide device having the cloud form microstructures thereon in accordance with the present invention;

FIG. 6B shows measurements from FIG. 6A,

FIG. 7 shows typically a third optical path on the first surface of the light guide device having the cloud form microstructures thereon in accordance with the present invention;

FIG. 8A shows schematically a first (W/L) arrangement of the cloud form microstructures on the first surface of the light guide device in accordance with the present invention;

FIG. 8B shows schematically a second (W/L) arrangement of the cloud form microstructures on the first surface of the light guide device in accordance with the present invention;

FIG. 8C shows schematically a third (W/L) arrangement of the cloud form microstructures on the first surface of the light guide device in accordance with the present invention;

FIG. 9A shows schematically measurements from FIG. 8A according to the third optical path along the B direction under a nature environment;

FIG. 9B shows schematically measurements from FIG. 8B according to the third optical path along the B direction under a nature environment;

FIG. 9C shows schematically measurements from FIG. 8C according to the third optical path along the B direction under a nature environment;

FIG. 10A shows schematically a first arrangement for testing gloss of the light guide device in accordance with the present invention;

FIG. 10B shows schematically a second arrangement for testing gloss of the light guide device in accordance with the present invention; and

FIG. 11 shows schematically the gloss values with respect to different experimental specimens.

### DESCRIPTION OF THE PREFERRED EMBODIMENT

The invention disclosed herein is directed to the light guide device, front-light module and reflective display apparatus. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the present invention, a front light guide device for enhancing optical homogeneity is mounted in front of the display surface of the reflective display panel, in which a plurality of cloud form microstructures is structured on the light-emitting surface of the front light guide device so as to obtain clear images with preferred aspect ratio and more satisfied homogeneity.

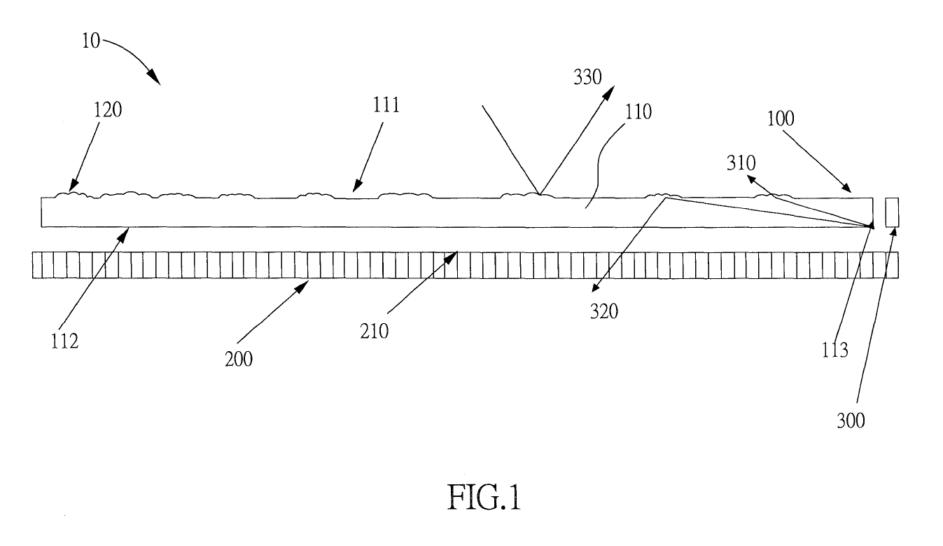

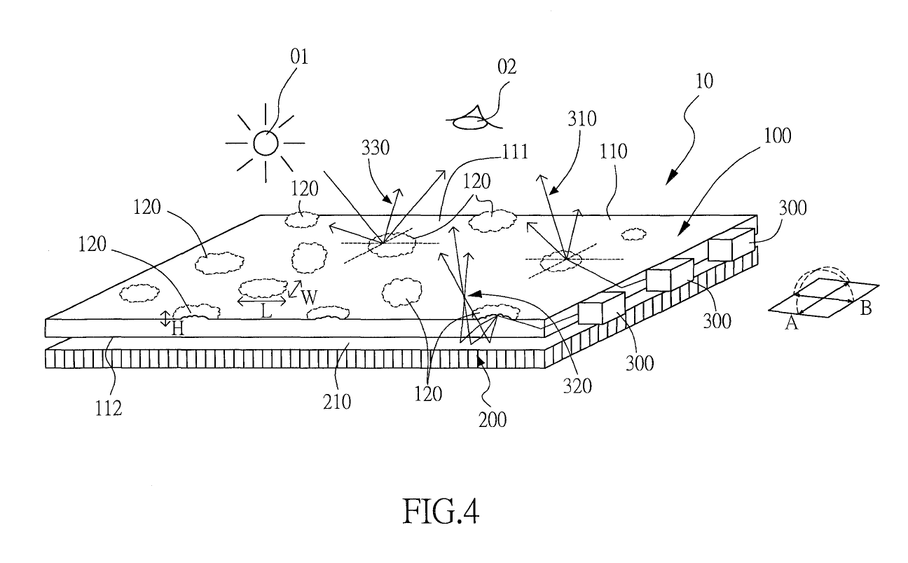

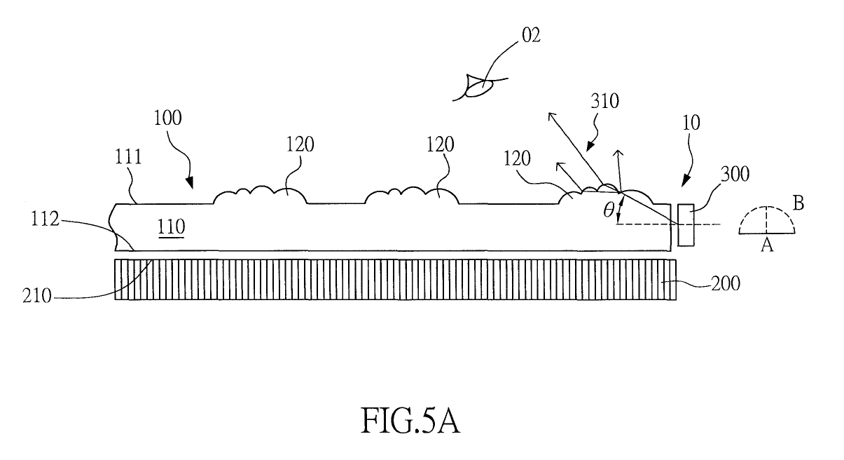

Referring now to FIG. 1 and FIG. 4, a cross-sectional view and a perspective view of the first embodiment of the reflective display apparatus in accordance with the present invention are schematically shown, respectively. The reflective display apparatus 10 includes a light guide device 100 mounted parallel in front of the display surface 210 of the reflective display panel 200. The light guide device 100 is a light guide plate having a main body 110, a first surface 111 (light-emitting surface), a second surface 112, a light-entering surface 113 (lateral side) and a plurality of cloud form microstructures 120. The first surface 111 and the second surface 112 are two opposing broader surfaces, parallel at large or slightly oblique to each other. The light-entering surface 113 (the lateral surface to the first and the second surfaces 111, 112) is a longitudinal narrow strip surface connecting perpendicularly at large in between the first surface 111 and the second surface 112. The first surface 111 is located at the distant side of the main body 110 with respect to the display surface 210, and acts as the light-emitting surface of the light guide device 100. The second surface 112, a light-permissible plane preferably with excellent light transmittance, is located adjacent to the display surface 210 of the reflective display panel 200. The lateral surface 113 (i.e. the light-entering surface) is located adjacent to a light source 300 (at least one) for introducing lights of the foreign light source 300 into the light guide device 100. In the present invention, the light source 300 can be a line light source formed by a light tube, or a plurality of point light sources formed by plural LEDs.

As shown, the plurality of cloud form microstructures 120 is located on the first surface 111 of the light guide device 100. In one embodiment of the present invention, the distribution density of the cloud form microstructures 120 on the first surface 111 depends on corresponding distances of the microstructures 120 to the light source 300. Namely, the more distant the area is on the first surface 111 with respect to the light source 300, the denser the cloud form microstructures 120 are distributed. Equally, the nearer the area is on the first surface 111 with respect to the light source 300, the sparser the cloud form microstructures 120 are distributed.

Optical energy of the light source 300 is introduced into the main body 110 of the light guide device 100 through the light-entering surface 113 (the lateral surface). It is noted that a portion of the optical energy (in a form of light beams) can hit on the cloud form microstructures 120 so as to form a first optical path 310, a second optical path 320 and a third optical path 330. As shown in FIG. 1, the first optical path 310 is a penetration path for the light beam to directly penetrate through the light-emitting surface 111 (the first surface) and leave the main body 110. On the other hand, the second optical path 320 is to deflect the light beam hitting the cloud form microstructures 120 back to the main body and heading for the second surface 112 and the displace surface 210 adjacent to the second surface 112. In addition, the third optical path 330 is the path for either refracting or reflecting the foreign nature lights so as to enhance the illumination as well as to increase the clarity of the display panel.

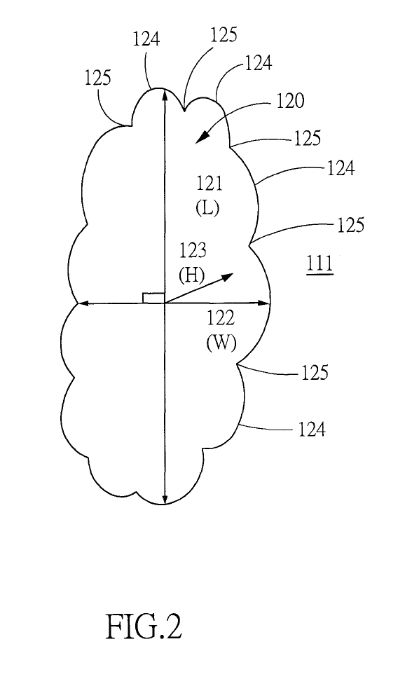

Referring now to FIG. 2, a top view of the cloud form microstructure 120 on the first surface 111 of the light guide device 100 is schematically shown. Each of the cloud form microstructures 120 has an outer contour while sitting on the first surface 111. The outer contour has at least three connecting points 125 and a plurality of curved lines 124. Each of the plural curved lines 124 is to bridge the two adjacent connecting points 125 so as to contribute individually to form integrally as a whole the complete outer contour of the respective cloud form microstructure 120. The outer contour, i.e. the projection boundary of the respective cloud form microstructure 120 on the first surface 111, has a maximum length (L) 121 and a maximum width (W) 122 measured from the maximum length 121 in a perpendicular manner. Further, the corresponding cloud form microstructure 120 has a maximum height (H) 123 measured vertically from the first surface 111, not necessary at the intersection of the maximum length 121 and the maximum width 122, to the corresponding highest roof point of the cloud form microstructure 120. In the present invention, the measuring of the aforesaid L, W and H can be performed by observing the outer contour on the first surface 111 in a top-view manner upon the corresponding cloud form microstructure 120 of the light guide device 100. The maximum length (L) 121 can be defined to be the maximum distance between any two points on the outer contour. Then, sort out all the lines that connect two points on the outer contour and are perpendicular to the line defining the maximum length (L) 121 to locate the maximum one and define it as the maximum width (W) 122. The maximum height (H) 123 is defined to be the maximum vertical rising or falling of the cloud form microstructure 120 to the first surface 111. In the present invention, the cloud form microstructure 120 can be a pop-up or concave structure with respect to the first surface 111. Yet, in the present embodiment, the cloud form microstructure 120 is a pop-up structure over the first surface 111.

In one embodiment of the present invention, the ratio of the maximum length (L) to the maximum width (W) is ranged between 1:1 and 5:1, and the ratio of the maximum length (L) to the maximum height (H) is ranged preferably between 2.5:1 and 36:1, and more preferably between 22:1 and 36:1. For plural cloud form microstructures 120 are included on the first surface 111 of the light guide device 100, the calculations of aforesaid ratios are based on the mean value of all the maximum lengths (L) of the plural cloud form microstructures 120, the mean value of all the maximum widths (W) of the plural cloud form microstructures 120, and the mean value of all the maximum heights (H) of the plural cloud form microstructures 120. Further, it should be noted that the plural cloud form microstructures 120 are individually and separately located on the first surface 111. Namely, individual outer contours of the respective cloud form microstructures 120 are not intersected.

The light-entering surface 113 (the lateral side) of the light guide device 100 allows a photo energy G in a light-beam form from the light source 300 to enter the main body 110. By introducing the cloud form microstructures, the photo energy G can be totally reflected while hitting any of the cloud form microstructures 120. Homogeneity in illumination throughout the main body 110 of the light guide device 100 can be further enhanced by utilizing the density arrangement of the cloud form microstructures 120. The incident angle of the photo energy G is amended by the corresponding cloud form microstructures 120 so as to produce deflected optical paths such as the first optical path 310 and/or the second optical path 320 to directly emit through the first surface 111 and further to reach naked eyes of an observer 02, and/or to penetrate the second surface 112 to reach the display surface 210, be reflected by the display surface 210 to enter back the main body 110, and finally penetrate the first surface 111 to leave for the naked eyes 02. In this embodiment, penetration and reflection contributed by foreign nature lights 01 need to be taken care while in applying the light guide device 100 to the front-light module. As shown in FIG. 4, the third optical path 330 can be produced by the plural cloud form microstructures 120 on the first surface 111 of the light guide device 100, through which the nature lights 01 would be directly refracted by the cloud form microstructures 120 to go toward the naked eyes of the observer 02.

Further, the light guide device 100 of the reflective display panel 10 is located in front of the display surface 210. Therefore, it is important to protect the light guide device 100 from possible damages by the consumers. In the present invention, the first surface 111 of the light guide device can have an anti-fouling parameter ranged between 90° and 150° in the water contact angle the surface. The height (H) 123 of the cloud form microstructures 120 can cover any possible scratch by having a scratch-resisting parameter under steel wire abrasion up to 100 cycles/150 g. The surface hardness parameter for the first surface 111 can be ranged between HB and 6H. Thereby, the effects of the scratches and the finger prints can be reduced to a class between “invisible” and “visible but easy-to-be-brushed off”.

In the present invention, the main body 110 of the light guide device 100 can be produced from an extruding process to have a thickness ranged between 0.1 mm and 0.3 mm, and the material thereof can be a single optical material or a composite optical material. The main body 110 can have a light transmittance no less than 80%, preferably higher than 85%. Material for the main body 110 can be one or a combination of a PMMA (Polymethyl Methacrylate), a PC (Polycarbonate), a PS (Polystyrene), and an MS (Styrene-α-methylstyrene-copolymer). However, to the skill in the art, he/she shall understand there are still other qualified materials available for forming the main body 110 of the present invention. Namely, the aforesaid material selections of the present invention are not used to limit the material of the main body 110 to the optical class materials.

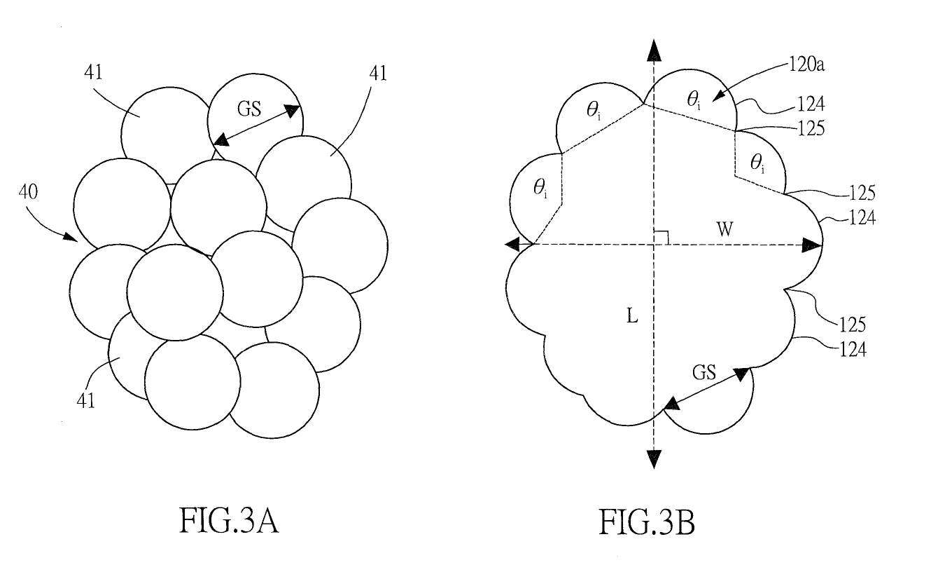

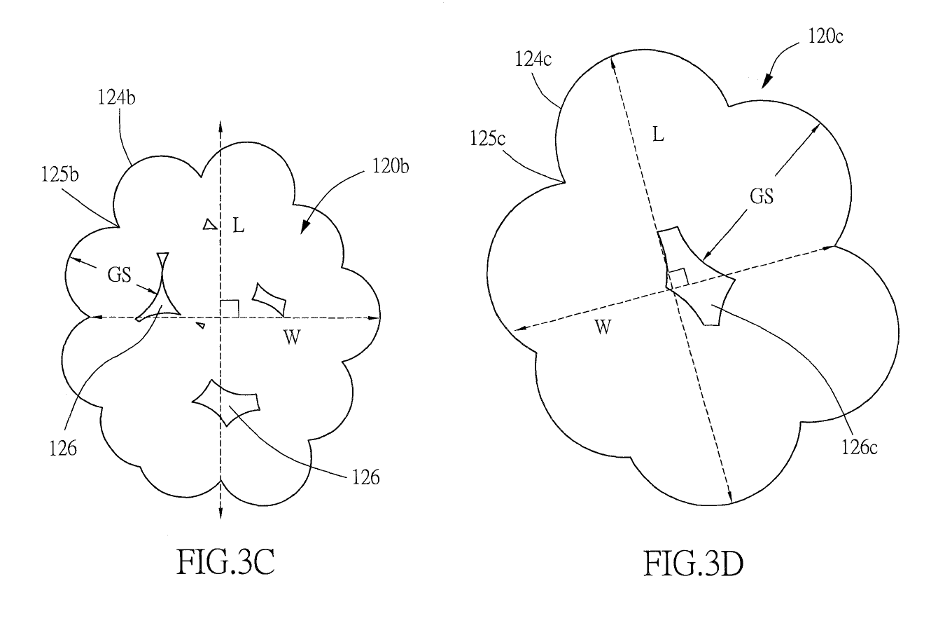

In the present invention, one method for forming the plural cloud form microstructures 120 on the first surface 111 of the light guide device 100 is to apply a sand blaster to produce a plurality of concave sand-coated molds 40 (as shown in FIG. 3A) resembled to the cloud form microstructures, and then use the sand-coated molds to roll over the first surface 111 of the main body 110 of the light guide device 100 while in the extruding process. Thereby, plural pop-up cloud form microstructures 120 in correspondence to the concave sand-coated molds can be thus produced on the first surface 111 of the main body 110.

In another embodiment, to produce concave-shape cloud form microstructures 120 on the first surface 111 of the light guide device 100, a tooling having a plurality of convex sand-coated molds, counter to the aforesaid tooling having a plurality of concave sand-coated molds, can be used to roll over the first surface 111 of the main body 110 of the light guide device 100 while in the extruding process. Thereby, plural concave cloud form microstructures 120 in correspondence to the convex sand-coated molds can be thus produced on the first surface 111 of the main body 110.

Referring now to FIG. 3A, an embodiment of the cloud form concave structures 40 on the tooling surface is schematically shown. For the cloud form concave structures 40 on the tooling are produced from a sand-blasting process. In the sand-blasting process, a sand blaster introduces high-speed round particles to impact at the tooling's surface so as to have each impact point formed a round-shape cavity 41. An independent cloud form concave structure 40 is then obtained by accumulating a plurality of overlapping or partly-overlapping cavities 41 on the tooling's surface. Obviously, the outer contour and the depth of the cloud form concave structure 40 are dependent on the shape, particle size and the setup of the sand blaster.

Referring now to FIG. 3B, FIG. 3C and FIG. 3D, various formations of the cloud form microstructures 120 but applying the same molds 40 of FIG. 3A in different extruding processes are respectively shown. As shown in FIG. 3B, the light guide device 100 extruded from the tooling having the cloud form concave structures 40 of FIG. 3A includes a first surface 111 having the cloud form microstructures 120a, in which the outer contour of the cloud form microstructures 120a is the same as that of the cloud form concave structures 40 on the tooling. The only difference in between is that the cloud form microstructures 120a of the light guide device 100 are pop-up structures, not a cavity assembly in the tooling. Namely, each curved line 124 of the outer contour of the cloud form microstructure 120a is a portion of a circle, which is defined by a diameter (GS), a center, a curvature radius (GS/2), and an angle θᵢ formed by the two connecting points 125 (the two ends of the curved line) and the center. Also, the maximum length (L) 121 is no less than the maximum width (W) 122, and the W 122 is larger than three times of the GS. Further, the GS is ranged between 40 μm and 200 μm, preferably between 40 μm and 100 μm. The θᵢ is ranged between 45° and 180°. It is noted that a lower bound of 45° is assigned to the θᵢ for, under such an angle or below, the curved line 124 would be close to a straight line, and also noted that an upper bound of 180° is assigned to the θᵢ for, under such an angle or above, optical performance of the outer contour for the cloud form microstructures 120a formed by the curved lines 124 would be poor.

As shown in FIG. 3B and FIG. 3C, some planar micro areas 126, 126c exist within the respective outer contours circled by the corresponding curved lines 124b, 124c and the corresponding connecting points 125b, 125c of the respective cloud form microstructures 120b, 120c. The existence of these micro areas 126, 126c is caused by the respective areas on the cloud form concave structures 40 of the tooling that are not sand-blasted during its sand-blasting process. Therefore, these micro areas 126, 126c would be planar and flush with the first surface 111 of the light guide device 100. In one embodiment of the present invention, the percentage of the total area of the micro areas 126, 126c to that of the respective cloud form microstructures 120b, 120c is less than 10%.

For the cloud form microstructures 120 are independently scattered on the first surface 111 of the light guide device 100, so spacing or empty rooms do exist on the first surface 111. In this embodiment, the distribution density of the cloud form microstructures 120 on the first surface 111 of the light guide device 100 is according to the granular sizes of the particles to be used in the sand-blasting process while in forming the tooling. Typical examples are shown as follows.

TABLE 1
Distribution densities of cloud form microstructures
with respect to different granular sizes

Granular size GS (μm)

| | 40 | 100 | 140 | 180 |
|---|---|---|---|---|
| Particle | +/−15 | +/−20 | +/−25 | +/−25 |
| distribution | | | | |
| (μm) | | | | |
| N(1/mm²) | 100-200 | 10-30 | 5-17 | 3-10 |
| Density (%) | 65-95 | 75-95 | 80-95 | 85-95 |

In Table 1, it is noted that the granular sizes are different in respective sand-blasting processes (with a tolerant range). For example, in the case that the average GS is 40 μm, the practical GS for the sand particles is within (40+/−15) μm, i.e. from (40−15)=25 μm to (40+15)=55 μm. Every unit square mini-meter (mm²) of the first surface 111 has a number N of the cloud form microstructures 120 ranged between 100 and 200. Namely, the distribution density (i.e. the coverage) of the cloud form microstructures 120 is ranged between 65% and 95%, and so forth.

As described, the distribution density of the cloud form microstructures 120 on the first surface 111 of the light guide device 100 is varied so as to achieve better optical performance. Namely, the criterion to determine the distribution density is that: the more distant the area is on the first surface 111 with respect to the light source 300, the denser the cloud form microstructures 120 are distributed. Equally, the nearer the area is on the first surface 111 with respect to the light source 300, the sparser the cloud form microstructures 120 are distributed. In the present invention, the number N of the cloud form microstructures 120 within a square mini-meter (mm²) is related to the mean GS of the sand particles used in forming the tooling. In term of the distribution density, the coverage of the cloud form microstructures 120 within a unit area is preferably ranged between 65% and 95%, the most preferable between 75% and 95%. Such a range is related to the H of the cloud form microstructures 120 on the first surface 111 of the light guide device 100. The purpose of the present invention to introduce varied distribution densities of the cloud form microstructures 120 is to benefit the transmission and homogeneity of the photo energy G in the main body 110 of the light guide device 100 from the foreign point light source 300. Further, in the present invention, areas of the first surface 111 outside the outer contours of the cloud form microstructures 120 are planar areas, while the areas within the outer contours are pop-up or concave curved areas (for example, the areas formed by partly overlapping spherical areas). The areas on the first surface 111 that present more severe changes in curvature are at the adjunction areas around the outer contours of the cloud form microstructures 120.

As described above, by introducing the cloud form microstructures 120 to the first surface 111 of the light guide device 100, three optical paths 310, 320, 330 would be produced. The light-scattering patterns for these three optical paths are various and have their own better modes according to different transmission directions. As shown in FIG. 4, directions for detecting the light-scattering patterns include a Direction A and a Direction B, in which Direction A is the direction parallel to the arrangement direction of the plural point light sources 300 (or parallel to the extending direction of the line light source), and Direction B is perpendicular to Direction A. According to Directions A and B, measurements upon the three optical paths 310, 320, 330 so as to locate the better modes can be carried out.

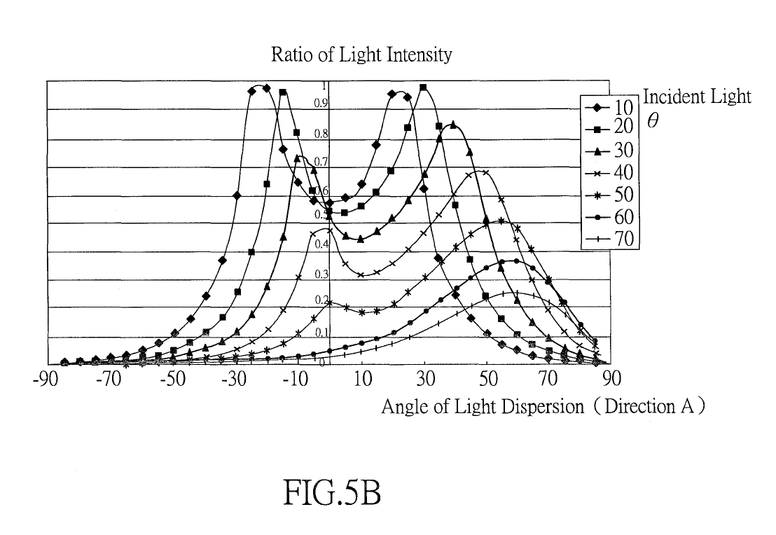

As shown in FIG. 5A and FIG. 5B, the first optical path 310 on the first surface 111 of the light guide device 100 having the cloud form microstructures 120 thereon in accordance with the present invention and the corresponding measurements of the light-scattering pattern are schematically shown, respectively. In the first optical path 310 as shown in FIG. 5A, the photo energy in a light-beam form from the light source 300 is introduced into the light guide device 100 through the light-entering surface 113. While the light beam hits the corresponding cloud form microstructure 120, the cloud form microstructure 120 can amend the light transmission angle while the light penetrates the cloud form microstructure 120 of the first surface 111, so as to bifurcate at least three light rays before reaching the observer 02. Therefore, the cloud form microstructure 120 of the present invention can enhance the slight-scattering performance upon the incident lights from an LED point source. That is to say that, under the same incident angle θ (i.e. the angle between the incident optical axis of the LED point source 300 and the horizontal direction), the refraction performance of the light penetrating the curved surfaces of the cloud form microstructure 120 can be enhanced. For a cloud form microstructure 120 having W/L=1 and H=1 μm, the light-scattering pattern of the first optical path along the A direction with respect to different incident angle θ is shown in FIG. 5B. It is found that, while the incident angle θ is smaller than 40°, the ratio of light intensity would present a light-division pattern having twin peaks. Thereby, the in-homogeneous incident lights from the light source 300 can be further homogenized while in emitting through the first surface 111 of the light guide device 100. Namely, the possible LED hot spot phenomenon induced by the point light sources 300 can be substantially lessened. On the other hand, while the incident angle θ is larger than 40°, very few or no light-division phenomenon in the ratio of light intensity is found. Hence, it can be concluded that the preferable incident angle θ along the firth optical path 310 is ranged from 0 to 40 degree, and more preferable between 0 and 30 degree.

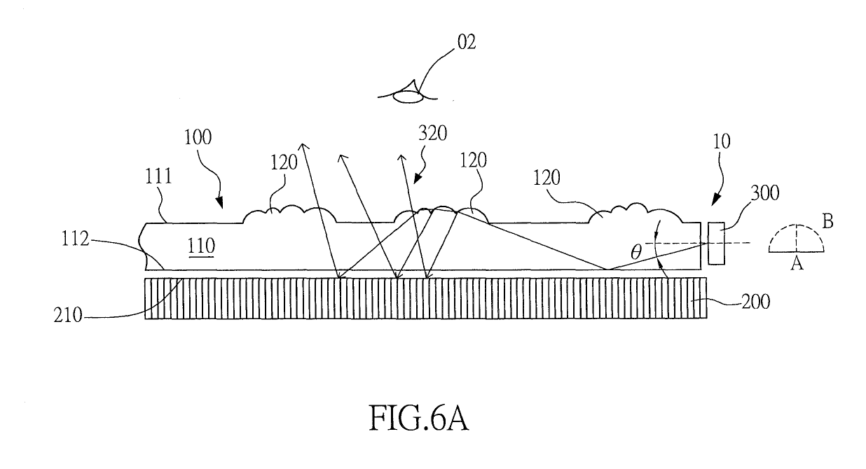

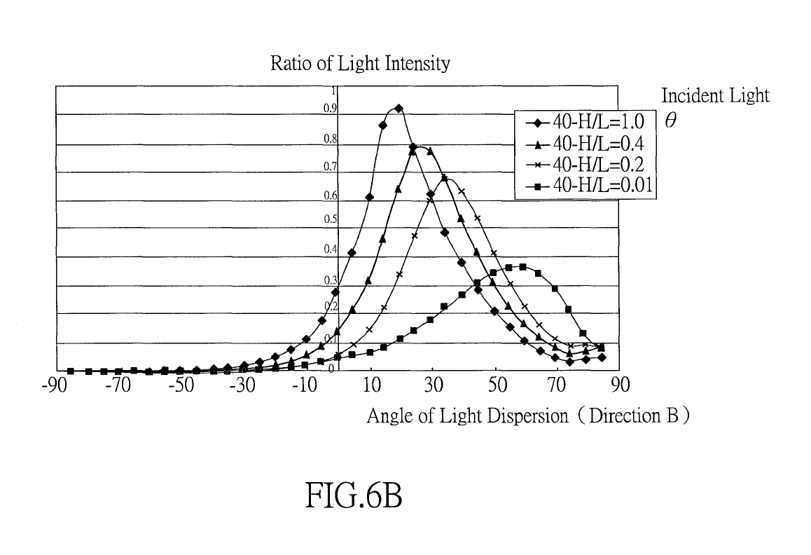

As shown in FIG. 6A and FIG. 6B, the second optical path 320 on the first surface 111 of the light guide device 100 having the cloud form microstructures 120 thereon in accordance with the present invention and the corresponding measurements of the light-scattering pattern are schematically shown, respectively. In the second optical path 320 of FIG. 6A, the photo energy in a light-beam form of the light source 300 enters the main body 110 of the light guide device 100 through the light-entering surface 113, and the downward light beam in the main body 110 firstly hits the display surface 210 and is reflected thereby at least once. The reflected light beam then reaches the corresponding cloud form microstructure 120 and is then deflected back to the display surface 210 of the reflective display panel 200. That is to say that, before the light beam/beams of the second optical path 320 penetrate the first surface 111 and further go toward the observer 02, the display surface 210 of the display panel 200 is illuminated at least twice by the same light beam. In the second optical path 320, while the light beam hits on the cloud form microstructure 120, the incident light beam is typically bifurcated at least into three offspring light beams. These three offspring light beams are then deflected individually back to hit on the display surface 210 of the reflective display panel 200. In FIG. 6B, it is shown that, in the case that the light-entering angle θ of the second optical path 320 is larger than 40 degree, the reflectivity of the light beam following the second optical path 320 is substantially increased so as to have more photo energy to be deflected to the display surface 210 and thus to increase the brightness of the reflective display panel 210 (observed by the observer 02). In this embodiment, a critical variable is the H value of the cloud form microstructure 120. It is noted that the mean value of the heights (H) of all the cloud form microstructures 120 on the first surface 111 is just equilibrium to the surface roughness (Rz) of the first surface 111. As shown in FIG. 6B for the light-scattering pattern along the B direction for lights having 40-degree light-entering angle θ and following the second optical path 320, the higher the H/L value is for the cloud form microstructure 120, the larger the peak value is in the light-scattering pattern (i.e. the highest ratio of light intensity), and also the smaller the angle corresponding to the highest peak is. In the second optical path 320 in accordance with the present invention, in the case that the H/L value of the cloud form microstructure 120 is ranged between 0.02 and 0.4 (i.e. L:H is between 1.5:1 and 50:1), the reflective display panel 200 can have an optimal brightness performance, and also then the angle for the peak can be within 40 degree. On the other hand, when H/L=1, the overall optical homogeneity is comparable poorer.

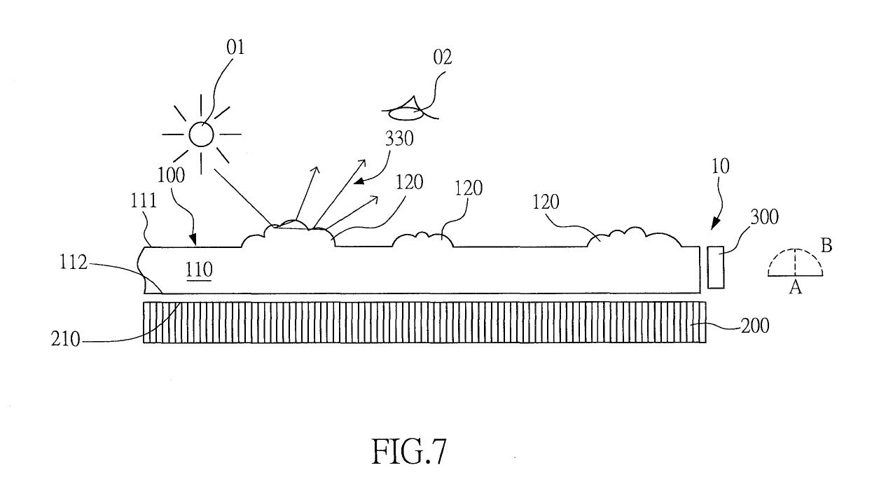

As shown in FIG. 7, the third optical path 330 on the first surface 111 of the light guide device 100 having the cloud form microstructures 120 thereon in accordance with the present invention is schematically shown. In the third optical path 330, the light beam originated from a foreign nature source 01 can be deflected and/or reflected at the exterior surface (the surface facing the observer 02) of the cloud form microstructure 120, and is bifurcated into three offspring light beams. The cloud form microstructure 120 has a maximum length L and a maximum width W. In this embodiment, both L and W are smaller than 0.6 mm. The L and W herein are respective mean values computed from all related data of the plural cloud form microstructures 120. In the third optical path 330 aiming at the environment existing nature lights 01, the L and W values would affect the image clarity of the reflective display panel 200. By providing the plurality of cloud form microstructures 120 to the first surface 111 (the light-emitting surface) of the light guide device 100, better display performance against glaring can be achieved.

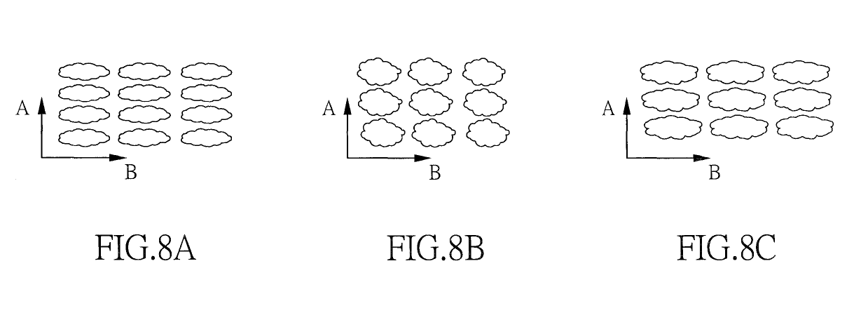

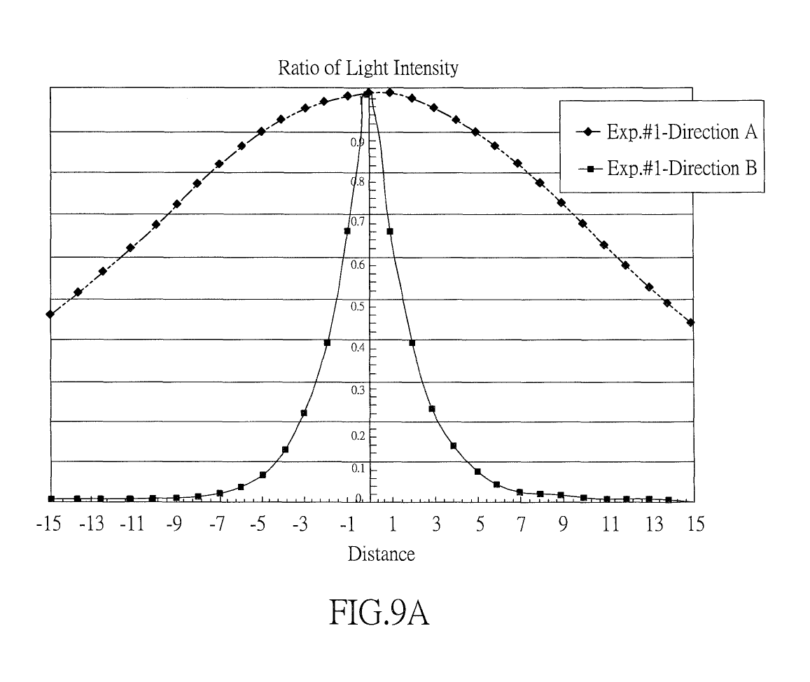

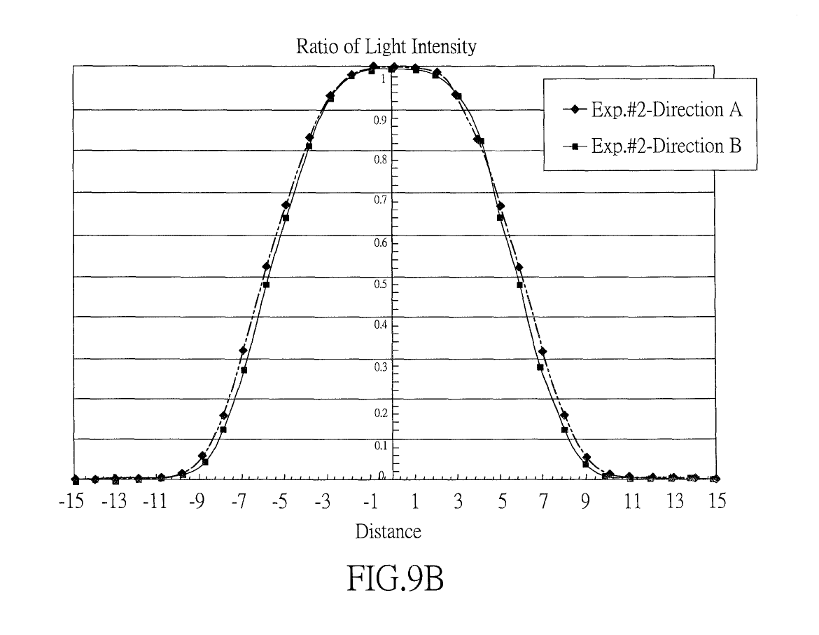

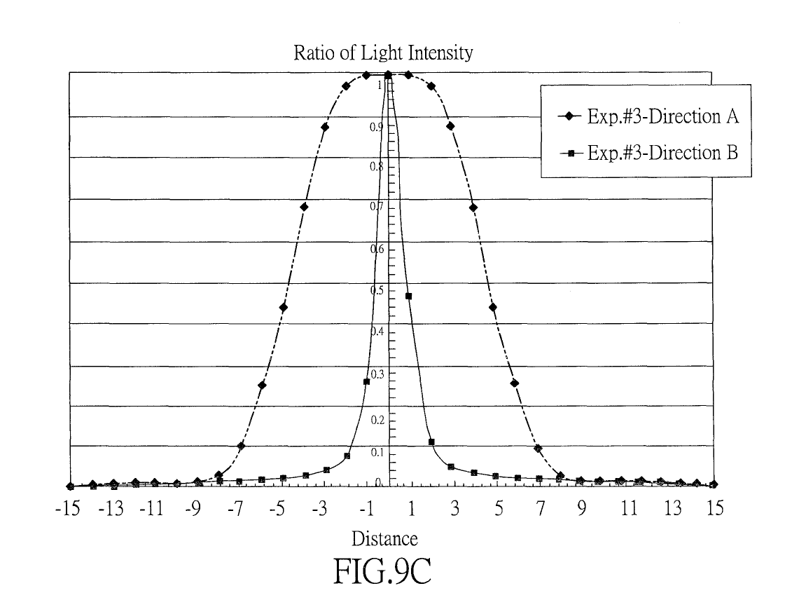

In this embodiment, three experiment specimens of the cloud form microstructures 120 with different W/L values are provided for testing. These three experiment specimens of the cloud form microstructures 120 are: (1) Exp. #1 shown in FIG. 8A with W/L=1/5, (2) Exp. #2 shown in FIG. 8B with W/L=1/1, and (3) Exp. #3 shown in FIG. 8C with W/L=1/2. By testing the third optical path 330 of these three specimens under nature lights 01, distributions of reflective strength are shown in FIG. 9A, FIG. 9B and FIG. 9C, respectively. In this testing, the ability in anti-glare and gloss are used as the evaluation flags. It is noted that, in the case that the W/L value of the corresponding cloud form microstructures 120 is ranged between 1:1 and 1:2 (referred to FIG. 9B and FIG. 9C), only the location close to the center (with distance 0) of the first surface 111 (the light-emitting surface) of the light guide device 100 is exposed to show severe glare phenomenon. On the other hand, in the case that the W/L value of the corresponding cloud form microstructures 120 is equal to 1:5 (referred to FIG. 9A), though a broader glare area is found along the A direction, yet the noticeable glare phenomenon along the B direction is again limited only to the central portion. Thus, the applicable W/L value for the cloud form microstructures 120 of the present invention is ranged between 1:1 and 1:5, and preferably between 1:1 and 1:2.

In the present invention, for the front-light module constructed by the light guide device 100 and the light source 300 are located in front of the reflective display panel 200 (i.e. close to the observer 02 than the display panel 200 is). Therefore, no matter whether the light source 300 is lighted on or not, the image quality cannot be downgraded. Namely, by compared to the display apparatus without the front-light module, the image quality for the apparatus having the front-light module of the present invention can include an irreducible visual clarity.

Referring now to the following Table 2 and Table 3, four experiment specimens having individual cloud form microstructures 120 with different surface finishes (Exp. #1, Exp. #2, Exp. #3 and Exp. #4) are introduced to compare with the sample specimen (Comp. Exp. #1). In this testing, thickness for these specimens can vary from 0.1 mm to 3.0 mm.

TABLE 2
Specs for the cloud form microstructures
120 on the light guide device

| | Average | Average | Average | Average |
|---|---|---|---|---|
| | Granular | Maximum | Maximum | Maximum |
| | size | Length | Width | Height H (μm) |
| | GS(μm) | L(μm) | W(μm) | (Roughness Rz) |
| Exp. #1 | 50 | 200 | 40 | 1.34 |
| Exp. #2 | 50 | 220 | 190 | 2.24 |
| Exp. #3 | 50 | 310 | 160 | 3.6 |
| Exp. #4 | 150 | 300 | 300 | 6.9 |
| Comp. Exp. #1 | — | — | — | 3.89 |

In Table 2, the light-guide plate for the Comp. Exp. #1 is a light guide device having micro dots and the same 0.4 mm thickness. For the light-guide plate of the Comp. Exp. #1 does not have the cloud form microstructure, so the GS, L, W, W/L and H/L are not available for the Comp. Exp. #1. In this embodiment, relations among roughness, transmissivity and Haze for all five specimens are tested. Based on the transmissivity changes among Exp. #1, Exp. #2, Exp. #3 and Exp. #4, the visual clarity at a state of “light up” the light source 300 and another state of “light off” the light source 300 are testing to determine an OK or an NG status, in which the OK status is a state of acceptable visual clarify, while the NG status is a state of unacceptable visual clarify. Results of the foregoing testing are as follows.

(1) The Haze and the Transmissivity are less correlated, but the Haze and the average H (i.e. the Roughness) are proportional related.

(2) The higher the Haze is, the less is the visual clarify. For example, the Rz value of Exp. #1 is the smallest in Table 3, and so is the Haze thereof. However, the reason for an NG status in the “light off” visual clarity is because the reflected image produced by the nature lights is a mirror reflection which would lead to an NG anti-glare status, and by which the visibility would be comprehensively reduced. In addition, Exp. #2 presents OK to anti-glare upon reflected image from the nature lights, and so is Exp. #3. Further, Exp. #4 has the highest Rz value and also the highest Haze value, but gets an NG in visibility for its rougher surface thereof (caused by the cloud form microstructures 120) leads to an orange phenomenon in reflection of the nature lights.

TABLE 3
Relations of the Roughness and Visual clarity for light guide
devices 100 with different clod form microstructures 120

| | | | | | Visual | Visual |
|---|---|---|---|---|---|---|
| | | | | | clarity | clarity |
| | | | Transmis- | Haze | (Light | (Light |
| | W/L | H/L | sivity (%) | (%) | Up) | Off) |
| Exp. #1 | 0.2 | 0.0067 | 91.4 | 7.1 | OK | NG |
| Exp. #2 | 1.0 | 0.028 | 90.7 | 8.4 | OK | OK |
| Exp. #3 | 0.5 | 0.045 | 90.6 | 22.5 | OK | OK |
| Exp. #4 | 1.0 | 0.023 | 93.4 | 79.3 | NG | NG |
| Comp. | — | — | 91.7 | 5.6 | OK | NG |
| Exp. #1 | | | | | | |

From Table 3, it is noted that, in the case of W/L within 0.5˜1.0 and H/L within 0.028˜0.045, an OK visual clarity can be obtained no matter if the “light up” or “light off” state is.

Besides the aforesaid clarity testing upon Exp. #1, Exp. #2, Exp. #3, Exp. #4 and Comp. Exp. #1, three additional specimens (Exp. #5, Exp. #6 and Exp. #7) are added to test on the luminance of the front-light modules for all eight specimens (Exp. #1˜#7 and Comp. Exp. #1). Results for this testing are listed in Table 4, in which the listing order is based on the scale of the Gloss. Testing is performed to detect the average central luminance, the average 9-point luminance and the 9-point brightness uniformity by a BM7 luminance meter.

TABLE 4
Relations of the Haze and the Luminance for light guide
devices 100 with different clod form microstructures 120

| | | | Central | Average | Brightness |
|---|---|---|---|---|---|
| | | | Luminance | Luminance | Uniformity |
| | Gloss | Haze (%) | (nits) | (nits) | (%) |
| Exp. #1 | High | 7.1 | 62 | 41 | 53 |
| Exp. #5 | High | 7.5 | 68 | 62 | 63 |
| Exp. #2 | High | 8.4 | 88 | 75 | 72 |
| Exp. #6 | Semi | 34.1 | 93 | 90 | 75 |
| Exp. #3 | Semi | 22.5 | 125 | 93 | 78 |
| Exp. #7 | Semi | 62.7 | 107 | 110 | 67 |
| Exp. #4 | Low | 79.3 | 112 | 102 | 42 |
| Comp. | High | 5.6 | 101 | 86 | 77 |
| Exp. #1 | | | | | |

From Table 4, it is noted that the brightness uniformity for any of Exp. #2, #3, #6 and Comp. Exp. #1 is greater than 70%. Namely, dark areas would be no problems to the visibility. The lowest average luminance happens to Exp. #1 who also has an NG 53% brightness uniformity. A reason for this is that the Exp. #1 has a low overall roughness, which will make a brighter side at distant areas; i.e. the light guide device performs poorly in the light-capturing efficiency. On the other hand, the highest average luminance happens to Exp. #4 who still has an NG 42% brightness uniformity. A reason for this is that the Exp. #1 has a high overall roughness, which will make a brighter area at the light-entering side and might further fail the light-guiding function in the corresponding light guide device. In the present embodiment, the gloss has an upper bound, which flags the trigger point to fail the light-guiding function in the corresponding light guide device. Also, under the situation of being over the upper bound, the visual clarity would become poor even at the “light up” state. From Table 4, in the case that the Haze value of the light guide device having plural cloud form microstructures is within 8.4%˜45%, the corresponding front-light module can obtain both a satisfied brightness uniformity and a better luminance. Further, though Comp. Exp. #1 does have good performance, in average luminance and central luminance, yet the associated anti-glare performance is an NG. Also, the display panel presents overlapping prints and thus still get an NG thereabout. Therefore, to have doted microstructures on the light guide device for performing the front-light module in front of the reflective display panel cannot provide satisfied anti-glare function, and is opt to have a problem in print-overlapping.

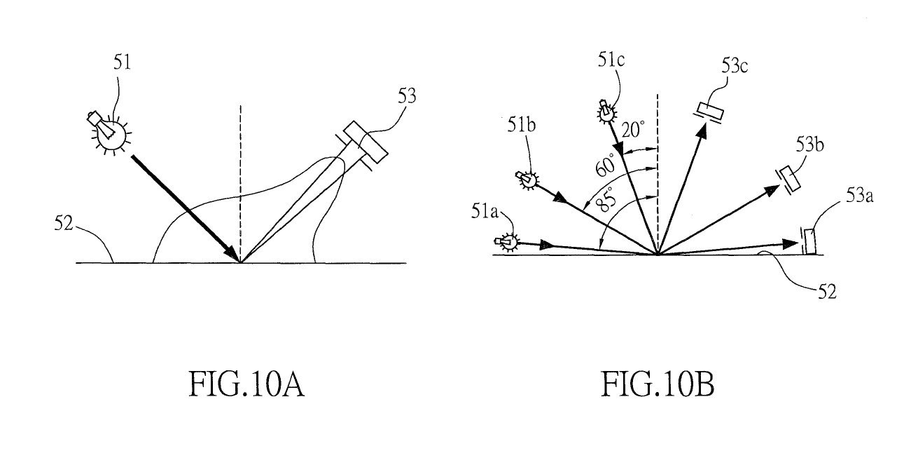

Referring now to FIG. 10A and FIG. 10B, two arrangements for testing gloss of the light guide device in accordance with the present invention are shown. In FIG. 10A, the gloss testing upon the light guide device is performed by providing a light source 51 to obliquely illuminate the surface 52 of the light guide device, and a detector 53 located at an opposite position about a normal line with respect to the incident light to measure the gloss value. The gloss value is to demonstrate the brightness percentage of an object surface upon a light reflection. Generally speaking, a higher gloss value signalizes a glossy surface, while a lower gloss value stands for a matte surface. The base for the gloss testing is to define 100 GU (Gloss unit) for a standard black glass plate, the measure meter is called a gloss meter, and an LED light source is applied. According to the international standard (ASTM-D523 or ISO-2813), three incident angles are tested; 20°, 60° and 85°. Also, according to the same standard, high, semi and low are three terms to define the gloss: (a) if the detected gloss is less than 10 GU@60°, re-test the gloss according to the 85° incident angle (defined to be “low” in gloss); (b)) if the detected gloss is larger than 70 GU@60°, re-test the gloss according to the 20° incident angle (defined to be “high” in gloss); and, (c) if the detected gloss is within 10˜70 GU@60°, no re-testing is needed (defined to be “semi” in gloss).

As shown in FIG. 10B, in this embodiment, aforesaid specimens Exp. #1, Exp. #2, Exp. #3, Exp. #4, Exp. #5, Exp. #6, Exp. #7 and Comp. Exp. #1 are applied again to perform individually the testing for the light source to generate 20°, 60° and 85° incident lights. Table 5 and Table 6 list the test results of the gloss values on the surface 52 of the light guide device while accompanies the light sources 51c, 51b and 51a and the corresponding detectors 53c, 53b and 53a.

TABLE 5
Relations of the Haze and the Gloss for light guide devices
100 with different clod form microstructures 120

| | | | | | | | Anti- |
|---|---|---|---|---|---|---|---|
| | | | | | Rz | Haze | Glare |
| | Gloss | 20° | 60° | 85° | (μm) | (%) | (AG) |
| Exp. #1 | High | 89 | 97 | 90.8 | 1.34 | 7.1 | No |
| Exp. #2 | High | 53.4 | 72.3 | 79.5 | 2.24 | 8.4 | Yes |
| Exp. #3 | Semi | 21.5 | 31.1 | 63.4 | 3.6 | 22.5 | Yes |
| Exp. #4 | Low | 2.1 | 7.5 | 16.3 | 6.9 | 79.3 | Yes |
| Comp. | High | 91 | 93 | 95 | 3.89 | 5.6 | No |
| Exp. #1 | | | | | | | |

TABLE 6
Relations of the Haze and the Gloss for light guide devices
100 with different clod form microstructures 120

| | | | | | | | Anti- |
|---|---|---|---|---|---|---|---|
| | | | | | Rz | Haze | Glare |
| | Gloss | 20° | 60° | 85° | (μm) | (%) | (AG) |
| Exp. #5 | High | 65.2 | 90.2 | 86.5 | 1.1 | 7.5 | No |
| Exp. #6 | Semi | 34 | 52.1 | 75.2 | 3.8 | 34.1 | Yes |
| Exp. #7 | Semi | 5.2 | 15.6 | 32.5 | 7.9 | 62.7 | Yes |

From Table 5, it is known that Exp. #1, Exp. #2, Exp. #5 and Comp. Exp. #1 are specimens with high gloss, Exp. #3, Exp. #6 and Exp. #7 are specimens with semi gloss, and Exp. #4 is a specimen with low gloss. According to a manufacturer's specs, typical gloss values in Table are bolded and underlined. According to the determination of AG by naked eyes, Exp. #1, Exp. #2, Exp. #4, Exp. #6 and Exp. #7 have features in anti-glaring. The relations of the Haze and the AG specimens are listed in Table 6. It shows from Table 5 and Table 6 that a higher haze value is related to a lower gloss value, which is obvious a counter relation. On the other hand, the higher the haze value is, the better is the AG feature (a proportional relation), but the poorer is the clarity (a counter relation). Further, the haze and the Rz of the light guide device also present a proportional relation. Therefore, while in designing the structure specs and distribution density of the cloud form microstructures on the first surface (the light-emitting surface) of the light guide device, following factors related to the luminance and the brightness uniformity should be considered as a whole for an optimal arrangement: (1) Haze, (2) Surface roughness, (3) Anti-glare feature, and (4) Visual clarity.

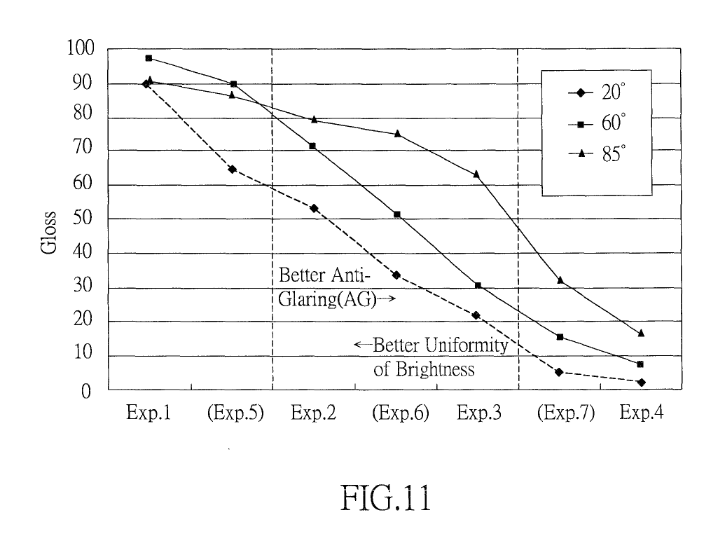

Referring now to FIG. 11, the gloss values with respect to different experimental specimens are shown. Referring back to FIG. 1 and Tables 5 and 6, specimens having AG feature and meeting conditions of the gloss being lower than 80 and the transmission Haze being close or less than 45% include Exp. #2, Exp. #6 and Exp. #3. Namely, these three experiment specimens satisfy the manufacturer's need in good optical performances.

In the present invention, the light guide device has the following advantages:

1. The plural cloud form microstructures can amend the incident angle of the photo energy by providing the first optical path directly to the observer, the second optical path to illuminate the display surface, and the third optical path to reflect the nature lights. Upon such an arrangement, the visual clarity can be increased.

2. The plural cloud form microstructures of the present invention can provide benefits in anti-scratch, anti-fouling, anti-glare, high hardness and anti-finger print, and thereby can strengthen the contact surface of the touch panel.

3. The light guide device of the present invention is manufactured by extruding processes, which is good for mass production.

While the present invention has been particularly shown and described with reference to a preferred embodiment, it will be understood by those skilled in the art that various changes in form and detail may be without departing from the spirit and scope of the present invention.

What is claimed is:

1. A light guide device, comprising:
a main body, having a first surface, a second surface opposing to the first surface, and a lateral surface connecting the first surface and the second surface; and
a plurality of cloud form microstructures, disposed on the first surface, each of the cloud form microstructures having an outer contour on the first surface, the outer contour consisted of at least three connecting points and a plurality of curved lines formed by connecting the adjacent connecting points;
wherein each of the cloud form microstructures has a maximum length (L) on the first surface, a maximum width (W) perpendicular to the maximum length on the first surface, and a maximum height (H) perpendicular to both the maximum length and the maximum width;
wherein a ratio of the maximum length (L) to the maximum width (W) is ranged between 1:1 and 5:1.

2. The light guide device according to claim 1, wherein the maximum height (H) is a vertical distance between a roof top point of the cloud form microstructure and the first surface, and a ratio of the maximum length (L) to the maximum height (H) is ranged between 2.5:1 and 36:1.

3. The light guide device according to claim 2, satisfying at least one of the following conditions:
condition 1: the cloud form microstructure be formed as a concave [symbol] shape or a pop-up shape;
condition 2: the first surface having an anti-fouling parameter ranged between 90° and 150° in the water contact angle;
condition 3: a surface hardness of the first surface being ranged between HB and 6H;
condition 4: a material of the main body being one of a single optical material and a composite optical material;
condition 5: transmissivity of the main body being no less than 85%; and
condition 6: a thickness of the main body being ranged between 0.1 mm and 3 mm.

4. The light guide device according to claim 1, wherein the first surface is a light-emitting surface of the light guide device, the second surface is a transmissive surface, and the lateral surface is a light-entering surface of the light guide device.

5. The light guide device according to claim 4, wherein the second surface is located adjacent to a display surface of a reflective display panel, and the lateral surface is close to at least a light source.

6. The light guide device according to claim 1, wherein each of the curved lines is a portion of a circle, which is defined by a diameter (GS), a center, a curvature radius (GS/2), and an angle θᵢ formed by the two connecting points (two ends of the curved line) and the center, wherein the L is no less than the W and the W is larger than three times of the GS.

7. The light guide device according to claim 6, wherein the GS is ranged between 40 μm and 200 μm, and the θi is ranged between 45° and 180°.

8. The light guide device according to claim 1, wherein the cloud form microstructure further includes at least one micro area equal-height with the first surface, an area percentage of the at least one micro area to the cloud form microstructure is less than 10%, and a coverage percentage of the cloud form microstructures on a unit area is ranged between 65% and 95%.

9. A front-light module, comprising:
a light source for providing a photo energy; and
a light guide device, having a light-entering surface close to the light-source for receiving the photo energy, further comprising:
a main body, having a first surface, a second surface opposing to the first surface, and a lateral surface connecting the first surface and the second surface; and
a plurality of cloud form microstructures, disposed on the first surface, each of the cloud form microstructures having an outer contour on the first surface, the outer contour consisted of at least three connecting points and a plurality of curved lines formed by connecting the adjacent connecting points;
wherein each of the cloud form microstructures has a maximum length (L) on the first surface, a maximum width (W) perpendicular to the maximum length on the first surface, and a maximum height (H) perpendicular to both the maximum length and the maximum width;
wherein a ratio of the maximum length (L) to the maximum width (W) is ranged between 1:1 and 5:1;
wherein the lateral surface is the light-entering surface and the first surface is a light-emitting surface of the light guide device;
wherein, after the photo energy enters the main body through the light-entering surface, at least a portion of the photo energy hit on the cloud form microstructures so as to form a first optical path and a second optical path.

10. The front-light module according to claim 9, wherein the maximum height (H) is a vertical distance between a roof top point of the cloud form microstructure and the first surface, and a ratio of the maximum length (L) to the maximum height (H) is ranged between 2.5:1 and 36:1.

11. The front-light module according to claim 9, wherein the second surface is a transmissive surface located adjacent to a display surface of a reflective display panel.

12. The front-light module according to claim 9, wherein each of the curved lines is a portion of a circle, which is defined by a diameter (GS), a center, a curvature radius (GS/2), and an angle θᵢ formed by the two connecting points (two ends of the curved line) and the center, wherein the L is no less than the W and the W is larger than three times of the GS.

13. The front-light module according to claim 12, wherein the GS is ranged between 40 μm and 200 μm, and the θi is ranged between 45° and 180°.

14. The front-light module according to claim 9, wherein the cloud form microstructure further includes at least one micro area equal-height with the first surface, an area percentage of the at least one micro area to the cloud form microstructure is less than 10%, and a coverage percentage of the cloud form microstructures on a unit area is ranged between 65% and 95%.

15. A reflective display apparatus, comprising:
a reflective display panel, having a display surface;
a light source for providing a photo energy; and
a light guide device, having a light-entering surface close to the light-source for receiving the photo energy, further comprising:
a main body, having a first surface, a second surface opposing to the first surface, and a lateral surface connecting the first surface and the second surface; and
a plurality of cloud form microstructures, disposed on the first surface, each of the cloud form microstructures having an outer contour on the first surface, the outer contour consisted of at least three connecting points and a plurality of curved lines formed by connecting the adjacent connecting points;
wherein each of the cloud form microstructures has a maximum length (L) on the first surface, a maximum width (W) perpendicular to the maximum length on the first surface, and a maximum height (H) perpendicular to both the maximum length and the maximum width;
wherein a ratio of the maximum length (L) to the maximum width (W) is ranged between 1:1 and 5:1;
wherein the lateral surface is the light-entering surface and the first surface is a light-emitting surface of the light guide device;
wherein, after the photo energy enters the main body through the light-entering surface, at least a portion of the photo energy hit on the cloud form microstructures so as to form a first optical path and a second optical path;
wherein the first optical path sends the photo energy directly out of the main body through the light-emitting surface and the second optical path is to deflect the photo energy toward the display surface close to the second surface.

16. The reflective display apparatus according to claim 15, wherein the plurality of cloud form microstructures is distributed according to distances in between with the light source.

17. The reflective display apparatus according to claim 15, wherein the maximum height (H) is a vertical distance between a roof top point of the cloud form microstructure and the first surface, and a ratio of the maximum length (L) to the maximum height (H) is ranged between 2.5:1 and 36:1.

18. The reflective display apparatus according to claim 15, wherein each of the curved lines is a portion of a circle, which is defined by a diameter (GS), a center, a curvature radius (GS/2), and an angle θᵢ formed by the two connecting points (two ends of the curved line) and the center, wherein the L is no less than the W and the W is larger than three times of the GS.

19. The reflective display apparatus according to claim 18, wherein the GS is ranged between 40 μm and 200 μm, and the θi is ranged between 45° and 180°.

20. The reflective display apparatus according to claim 15, wherein the cloud form microstructure further includes at least one micro area equal-height with the first surface, an area percentage of the at least one micro area to the cloud form microstructure is less than 10%, and a coverage percentage of the cloud form microstructures on a unit area is ranged between 65% and 95%.
